(19) United States
(12) Patent Application Publication
(10) Pub. No.: US 2024/0323951 A1
(43) Pub. Date: Sep. 26, 2024

(54) PREVENTING COLLISIONS BETWEEN CELL-SPECIFIC REFERENCE SIGNALS AND DEMODULATION REFERENCE SIGNALS

(71) Applicant: QUALCOMM Incorporated, San Diego, CA (US)

(72) Inventors: Sambit BEHURA, Hyderabad (IN); Varun WALIA, Hyderabad (IN); Anusha GANDHAM, Hyderabad (IN); Ashutosh GUPTA, Gangapur City (IN); Konstantin KUPERSHLAK, Ramat Gan (IL); Hongsan SHENG, San Diego, CA (US); Stefan BRUECK, Neunkirchen am Brand (DE)

(21) Appl. No.: 18/189,908

(22) Filed: Mar. 24, 2023

(51) Int. Cl. H04W 72/12; H04L 5/00; H04W 16/14

(52) U.S. Cl. CPC H04W 72/1215; H04L 5/0051; H04W 16/14

(57) ABSTRACT

Various aspects of the present disclosure generally relate to wireless communication. In some aspects, a user equipment (UE) may receive, in a slot via a dynamic spectrum sharing (DSS) spectrum, a plurality of cell-specific reference signals (CRSs) of a first radio access technology (RAT). The UE may receive, in the slot via the DSS spectrum, a plurality of demodulation reference signals (DMRSs) of a second RAT, wherein the plurality of DMRSs is associated with a Type-B physical downlink shared channel (PDSCH) scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH. Numerous other aspects are described.

### FIELD OF THE DISCLOSURE

Aspects of the present disclosure generally relate to wireless communication and to techniques and apparatuses for preventing collisions between cell-specific reference signals and demodulation reference signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE). The user equipment may include a memory and one or more processors coupled to the memory. The one or more processors may be configured to receive, in a slot via a dynamic spectrum sharing (DSS) spectrum, a plurality of cell-specific reference signals (CRSs) of a first radio access technology (RAT). The one or more processors may be configured to receive, in the slot via the DSS spectrum, a plurality of demodulation reference signals (DMRSs) of a second RAT, wherein the plurality of DMRSs is associated with a Type-B physical downlink shared channel (PDSCH) scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

Some aspects described herein relate to a method of wireless communication performed by a UE. The method may include receiving, in a slot via a DSS spectrum, a plurality of CRSs of a first RAT. The method may include receiving, in the slot via the DSS spectrum, a plurality of DMRSs of a second RAT, wherein the plurality of DMRSs is associated with a Type-B PDSCH scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

Some aspects described herein relate to an apparatus. The apparatus may include means for receiving, in a slot via a DSS spectrum, a plurality of CRSs of a first RAT. The apparatus may include means for receiving, in the slot via the DSS spectrum, a plurality of DMRSs of a second RAT, wherein the plurality of DMRSs is associated with a Type-B PDSCH scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

Some aspects described herein relate to a non-transitory computer-readable medium that stores a set of instructions by a UE. The set of instructions, when executed by one or more processors of the UE, may cause the UE to receive, in a slot via a DSS spectrum, a plurality of CRSs of a first RAT. The set of instructions, when executed by one or more processors of the UE, may cause the UE to receive, in the slot via the DSS spectrum, a plurality of DMRSs of a second RAT, wherein the plurality of DMRSs is associated with a Type-B PDSCH scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of aspects according to the disclosure in order that the detailed description that follows may be better understood. Additional features and advantages will be described hereinafter. The conception and specific instances disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some instances, those skilled in the art will understand that such aspects may be implemented in many different arrangements and scenarios. Techniques described herein may be implemented using different platform types, devices, systems, shapes, sizes, and/or packaging arrangements. For instance, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For instance, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating aspects of a wireless network, in accordance with the present disclosure.

FIG. 2 is a diagram illustrating an instance of a network node in

communication with a user equipment (UE) in a wireless network, in accordance with the present disclosure.

FIG. 3 is a diagram illustrating an instance of a disaggregated base station architecture, in accordance with the present disclosure.

FIG. 4 is a diagram illustrating an instance of a frame structure in a wireless communication network, in accordance with the present disclosure.

FIG. 5 is a diagram illustrating an instance of a slot format, in accordance with the present disclosure.

FIG. 6 is a diagram illustrating an instance of a cell-specific reference signal (CRS) rate-matching scheme that creates a collision between a Long Term Evolution (LTE) CRS and a New Radio (NR) demodulation reference signal (DMRS), in accordance with the present disclosure.

FIG. 7 is a diagram illustrating an instance of a process associated with preventing collisions between CRSs and DMRSs, in accordance with the present disclosure.

FIG. 8 is a diagram illustrating an instance of aspects involving preventing collisions between CRSs and DMRSs.

FIG. 9 is a diagram illustrating an instance of a process performed, in some aspects, by a UE, in accordance with the present disclosure.

FIG. 10 is a diagram an instance of an apparatus for wireless communication, in accordance with the present disclosure.

FIG. 11 is a diagram of instance of an apparatus for wireless communication, in accordance with the present disclosure.

### DETAILED DESCRIPTION

Dynamic spectrum sharing (DSS) may enable a 4G radio access technology (RAT) and 5G RAT to share transmission resources. DSS may sometimes lead to a collision between a 4G cell-specific reference signal (CRS) and a 5G demodulation reference signal (DMRS) in the same symbol of a slot. In some instances (e.g., when DSS is configured and a DMRS associated with a Type-B physical downlink shared channel (PDSCH) having a duration of ten symbols collides with a CRS), all the DMRSs in the slot may be incremented by one symbol, relative to a non-DSS configuration, to avoid the collision.

However, in some instances (e.g., when the DMRSs are associated with a Type-B PDSCH scheduled by downlink control information (DCI) format 1_0, and the Type-B PDSCH starts at a fourth symbol of the slot and has a duration of ten symbols), incrementing all the DMRSs in the slot by one symbol may create other collisions between a CRS and a DMRS in the slot. As a result, in some instances, the user equipment (UE) may fail to decode the PDSCH transmitted in the slot with the DMRS and the CRS. For instance, if the PDSCH is a MSG2 transmission of a random access procedure, then the random access procedure may fail even when all the DMRSs in the slot are incremented by one symbol.

Some techniques are described herein for preventing collisions between CRSs and DMRSs. In some aspects, a network node may transmit, and a UE may receive, in a slot via a DSS spectrum, a plurality of CRSs of a first RAT (e.g., a 4G RAT). The plurality of CRSs may include a first CRS at a first symbol of the slot, a second CRS at a fifth symbol of the slot, a third CRS at an eighth symbol of the slot, and a fourth CRS at a twelfth symbol of the slot.

The network node may transmit, and the UE may receive, in the slot via the DSS spectrum, a plurality of DMRSs of a second RAT (e.g., a 5G RAT). The plurality of DMRSs may be associated with a Type-B PDSCH scheduled by downlink control information format 1_0, and the Type-B PDSCH may start at a fourth symbol of the slot and have a duration of ten symbols.

The slot contains no collision between any CRS of the first RAT and any DMRS associated with the Type-B PDSCH (e.g., the slot is collision-free). Because the slot contains no collision between any CRS of the first RAT and any DMRS associated with the Type-B PDSCH, the UE may successfully decode the Type-B PDSCH (e.g., based on the DMRSs). For instance, in case the Type-B PDSCH is a MSG2 transmission of a random access procedure, the random access procedure may succeed.

In some aspects, each DMRS in the slot and associated with the Type-B PDSCH may be incremented by two symbols relative to a non-DSS configuration. These aspects may be backward-compatible for UEs capable of incrementing all the DMRSs, relative to a non-DSS configuration, by one symbol. In some aspects, one DMRS is incremented or decremented by one symbol relative to a non-DSS configuration. These aspects may permit the UE to stably decode the PDSCH based on the front-loaded DMRS located at the symbol where the PDSCH starts.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For instance, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) RAT, aspects of the present disclosure can be applied to other RATs, such as a 3G RAT, a 4G RAT, and/or a RAT subsequent to 5G (e.g., 6G).

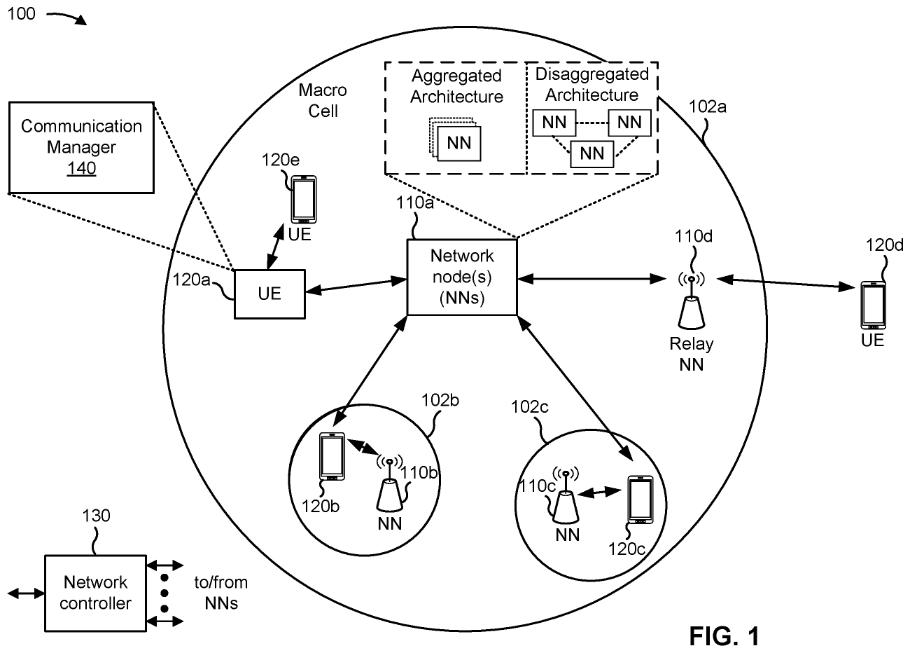

FIG. 1 is a diagram illustrating aspects of a wireless network 100, in accordance with the present disclosure. The wireless network 100 may be or may include elements of a 5G (e.g., NR) network and/or a 4G (e.g., Long Term Evolution (LTE)) network, among other instances. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. In some aspects, a network node 110 may be an aggregated network node, meaning that the aggregated network node is configured to utilize a radio protocol stack that is physically or logically integrated within a single radio access network (RAN) node (e.g., within a single device or unit). In some aspects, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some aspects, a network node 110 is or includes a network node that communicates with UEs 120 via a radio access link, such as an RU. In some aspects, a network node 110 is or includes a network node that communicates with other network nodes 110 via a fronthaul link or a midhaul link, such as a DU. In some aspects, a network node 110 is or includes a network node that communicates with other network nodes 110 via a midhaul link or a core network via a backhaul link, such as a CU. In some aspects, a network node 110 (such as an aggregated network node 110 or a disaggregated network node 110) may include multiple network nodes, such as one or more RUs, one or more CUs, and/or one or more DUs. A network node 110 may include, for instance, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some aspects, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some aspects, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some aspects, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For instance, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For instance, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For instance, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For instance, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for instance, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for instance, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as narrowband IoT (NB-IoT) devices. Some UEs 120 may be considered a Customer Premises Equipment. A UE 120 may be included inside a housing that houses components of the UE 120, such as processor components and/or memory components. In some aspects, the processor components and the memory components may be coupled together. For instance, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a network node 110 as an intermediary to communicate with one another). For instance, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such aspects, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For instance, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For instance, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, in a slot via a DSS spectrum, a plurality of CRSs of a first RAT; and receive, in the slot via the DSS spectrum, a plurality of DMRSs of a second RAT, wherein the plurality of DMRSs is associated with a Type-B PDSCH scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH. Additionally, or alternatively, the communication manager 140 may perform one or more other operations described herein.

As indicated above, FIG. 1 is provided as an instance. Other instances may differ from what is described with regard to FIG. 1.

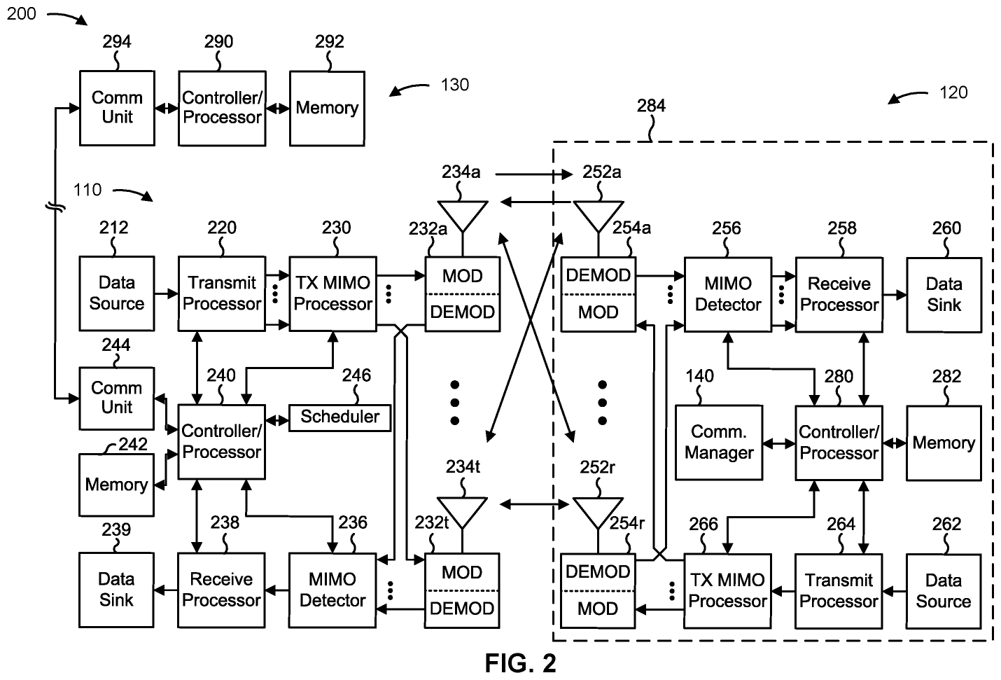

FIG. 2 is a diagram illustrating an instance 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of instance 200 includes one or more radio frequency components, such as antennas 234 and a modem 232. In some instances, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a CRS or a DMRS) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For instance, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For instance, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other instances. In some aspects, one or more components of the UE 120 may be included in a housing 284.

The network controller 130 may include a communication unit 294, a controller/processor 290, and a memory 292. The network controller 130 may include, for instance, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other instances. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

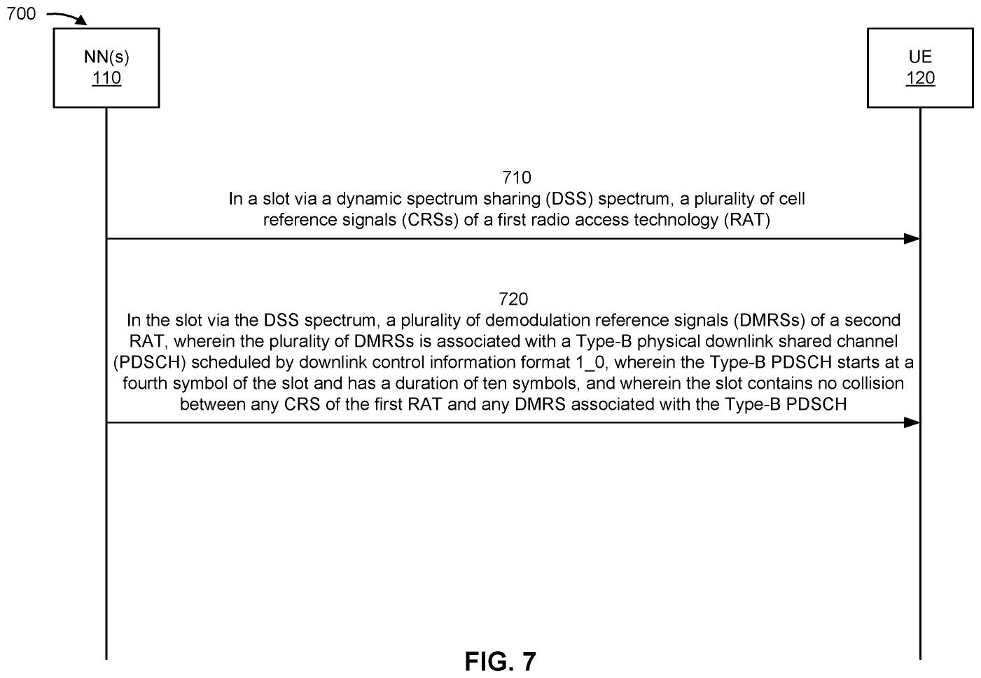

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some aspects, the modem 254 of the UE 120 may include a modulator and a demodulator. In some aspects, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some aspects, the modem 232 of the network node 110 may include a modulator and a demodulator. In some aspects, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-10).

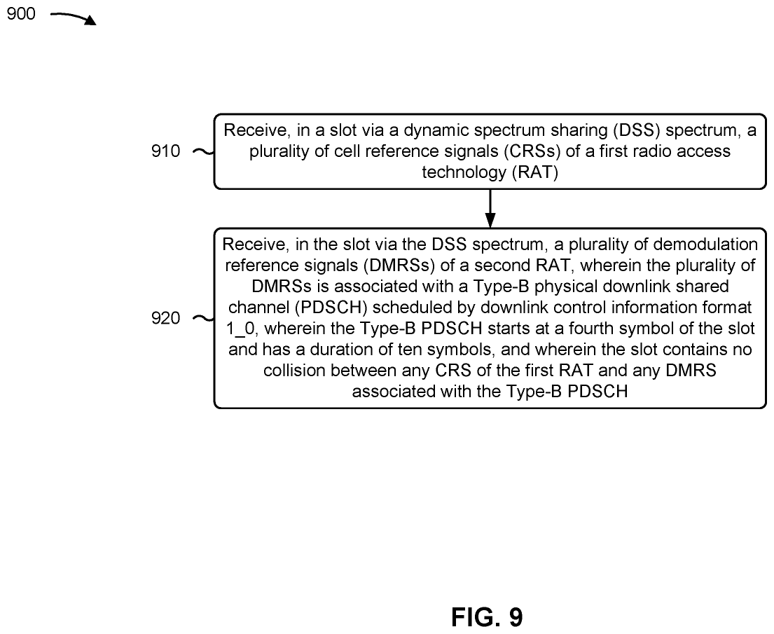

The controller/processor 240 of the network node 110, the controller/processor 280 of the UE 120, and/or any other component(s) of FIG. 2 may perform one or more techniques associated with preventing collisions between CRSs and DMRSs, as described in more detail elsewhere herein. For instance, the controller/processor 240 of the network node 110, the controller/processor 280 of the UE 120, and/or any other component(s) of FIG. 2 may perform or direct operations of, for instance, process 700 of FIG. 7, process 900 of FIG. 9, and/or other processes as described herein. The memory 242 and the memory 282 may store data and program codes for the network node 110 and the UE 120, respectively. In some aspects, the memory 242 and/or the memory 282 may include a non-transitory computer-readable medium storing one or more instructions (e.g., code and/or program code) for wireless communication. For instance, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for instance, process 700 of FIG. 7, process 900 of FIG. 9, and/or other processes as described herein. In some aspects, executing instructions may include running the instructions, converting the instructions, compiling the instructions, and/or interpreting the instructions, among other instances.

In some aspects, the UE includes means for receiving, in a slot via a DSS spectrum, a plurality of CRSs of a first RAT; and/or means for receiving, in the slot via the DSS spectrum, a plurality of DMRSs of a second RAT, wherein the plurality of DMRSs is associated with a Type-B PDSCH scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH. The means for the UE to perform operations described herein may include, for instance, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For instance, the functions described with respect to the transmit processor 264, the receive processor 258, and/or the TX MIMO processor 266 may be performed by or under the control of the controller/processor 280.

As indicated above, FIG. 2 is provided as an instance. Other instances may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For instance, a base station (such as a Node B (NB), an evolved NB (eNB), an NR base station, a 5G NB, an access point (AP), a TRP, or a cell, among other instances), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some aspects, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other aspects.

Base station-type operation or network design may consider aggregation characteristics of base station functionality. For instance, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

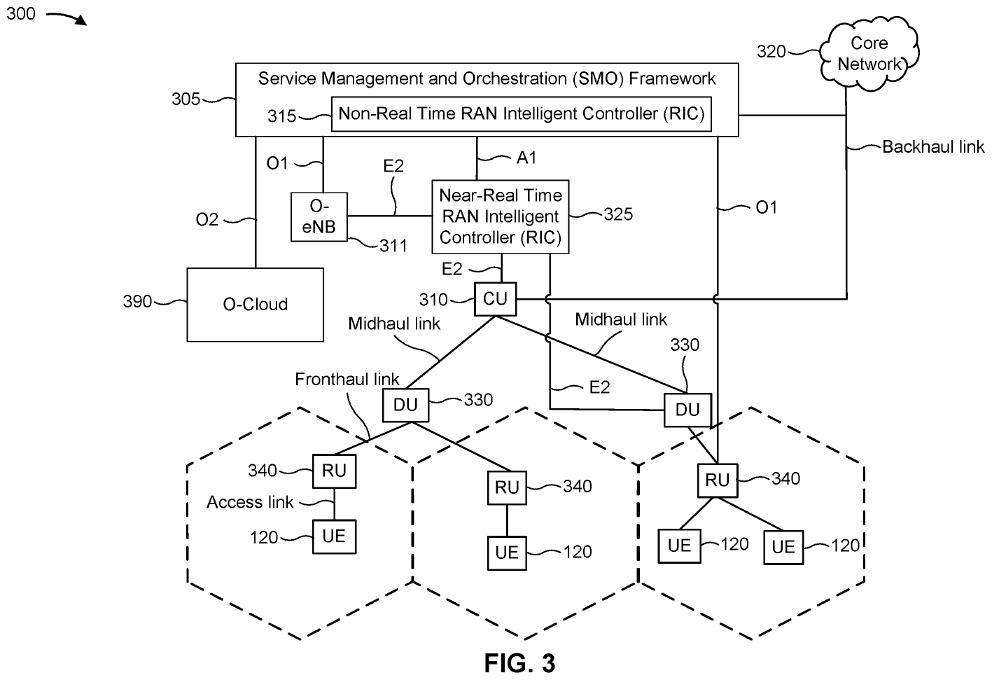

FIG. 3 is a diagram illustrating an instance of a disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some aspects, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other instances. Each control function can be implemented with an interface configured to communicate signals with other control functions hosted by the CU 310. The CU 310 may be configured to handle user plane functionality (for instance, Central Unit-User Plane (CU-UP) functionality), control plane functionality (for instance, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other instances. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other instances. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT. performing an iFFT, digital beamforming, or PRACH extraction and filtering, among other instances, based on a functional split (for instance, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325.

The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some aspects, the Non-RT RIC 315 or the Near-RT RIC 325 may be configured to tune RAN behavior or performance. For instance, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an instance. Other instances may differ from what is described with regard to FIG. 3.

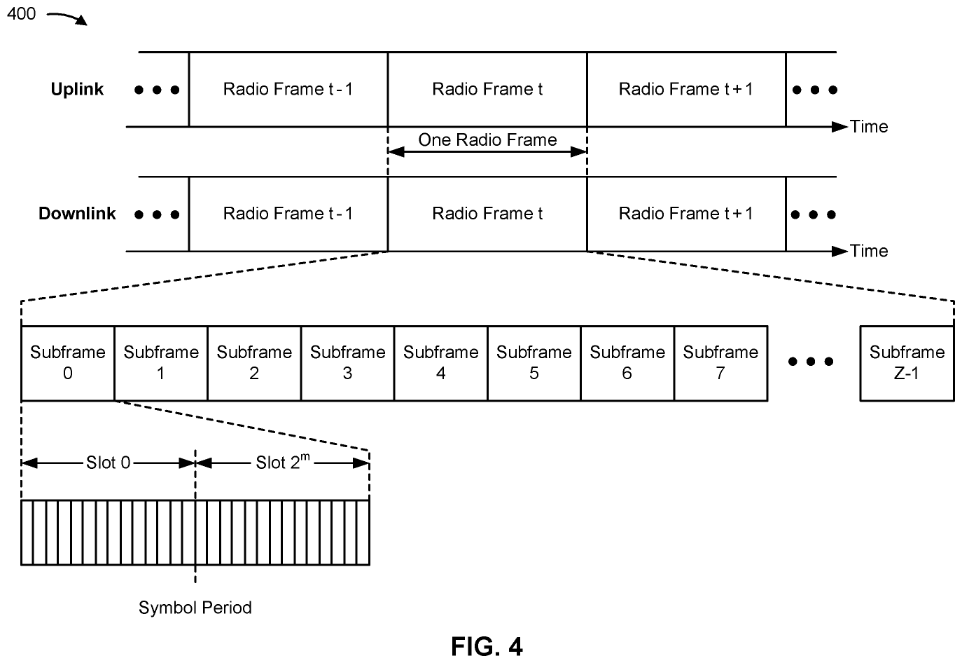

FIG. 4 is a diagram illustrating an instance 400 of a frame structure in a wireless communication network, in accordance with the present disclosure. The frame structure shown in FIG. 4 is for frequency division duplexing (FDD) in a telecommunication system, such as Evolved Universal Mobile Telecommunications System Terrestrial Radio Access (E-UTRA) (i.e., LTE) or NR. The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z-1). Each subframe may have a predetermined duration (e.g., 1 ms) and may include a set of slots (e.g., 2 m slots per subframe are shown in FIG. 4, where m is an index of a numerology used for a transmission, such as 0, 1, 2, 3, 4, or another number). Each slot may include a set of L symbol periods. For instance, each slot may include fourteen symbol periods (e.g., as shown in FIG. 4), seven symbol periods, or another number of symbol periods. In a case where the subframe includes two slots (e.g., when m=1), the subframe may include 2L symbol periods, where the 2L symbol periods in each subframe may be assigned indices of 0 through 2L-1. In some aspects, a scheduling unit for the FDD may be frame-based, subframe-based, slot-based, mini-slot based, or symbol-based.

As indicated above, FIG. 4 is provided as an instance. Other instances may differ from what is described with respect to FIG. 4.

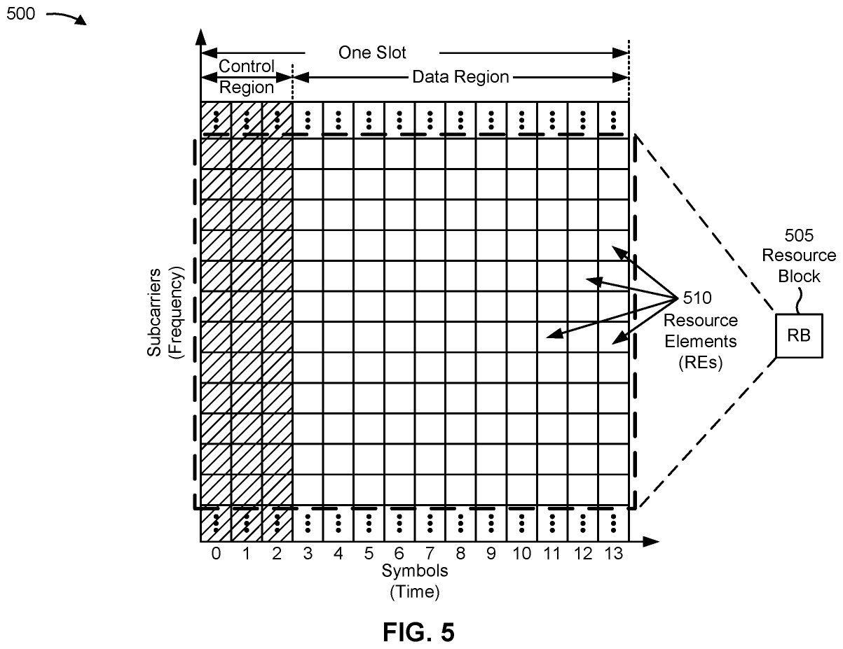

FIG. 5 is a diagram illustrating an instance 500 of a slot format, in accordance with the present disclosure. As shown in FIG. 5, time-frequency resources in a radio access network may be partitioned into resource blocks, shown by a single resource block (RB) 505. An RB 505 is sometimes referred to as a physical resource block (PRB). An RB 505 includes a set of subcarriers (e.g., 12 subcarriers) and a set of symbols (e.g., 14 symbols) that are schedulable by a network node 110 as a unit. In some aspects, an RB 505 may include a set of subcarriers in a single slot. As shown, a single time-frequency resource included in an RB 505 may be referred to as a resource element (RE) 510. An RE 510 may include a single subcarrier (e.g., in frequency) and a single symbol (e.g., in time). A symbol may be an orthogonal frequency division multiplexing (OFDM) symbol. An RE 510 may be used to transmit one modulated symbol, which may be a real value or a complex value.

In some telecommunication systems (e.g., NR), RBs 505 may span 12 subcarriers with a subcarrier spacing of, for instance, 15 kilohertz (kHz), 30 kHz, 60 kHz, or 120 kHz, among other aspects, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

As indicated above, FIG. 5 is provided as an instance. Other instances may differ from what is described with respect to FIG. 5.

DSS may enable a first RAT to share transmission resources with a second RAT. In some aspects, an LTE system and an NR system may dynamically share spectrum (e.g., downlink time and/or frequency resources) within a particular subframe of a radio frame.

The subframe may include multiple RBs, each of which includes different types of REs (e.g., REs that carry different types of signals or channels). Among others, the REs may include LTE CRS REs and NR PDSCH with LTE CRS rate-matching REs.

The LTE CRS REs may be used to carry CRSs. CRSs are used in LTE for cell search and initial acquisition, downlink channel quality measurements, and/or downlink channel estimation for coherent demodulation/detection at the UE. Because the LTE CRS REs include CRSs for LTE, the LTE CRS REs cannot be used to transmit data for NR (on the NR PDSCH) when time-frequency resources are being shared in DSS. Thus, when a network node schedules NR data in the RB, the network node performs rate-matching to refrain from transmitting NR data (on the NR PDSCH) in the LTE CRS REs that include the LTE CRS, and the UE drops the LTE CRS REs when decoding the NR data (e.g., by not using the information transmitted in the LTE CRS REs when decoding the NR data, by ignoring the information transmitted in these REs when decoding the NR data, by discarding the information transmitted in these REs when decoding the NR data, or the like). The NR data transmitted on the NR PDSCH is, instead, transmitted in the NR PDSCH REs with LTE CRS rate-matching. In some aspects, the UE may be configured (e.g., RRC configured) with a higher-layer parameter indicating a pattern for rate matching around LTE CRS (e.g., an lte-CRS-ToMatchAround parameter). In this way, DSS operation is enabled by NR PDSCH rate matching around LTE CRS in the same serving cell.

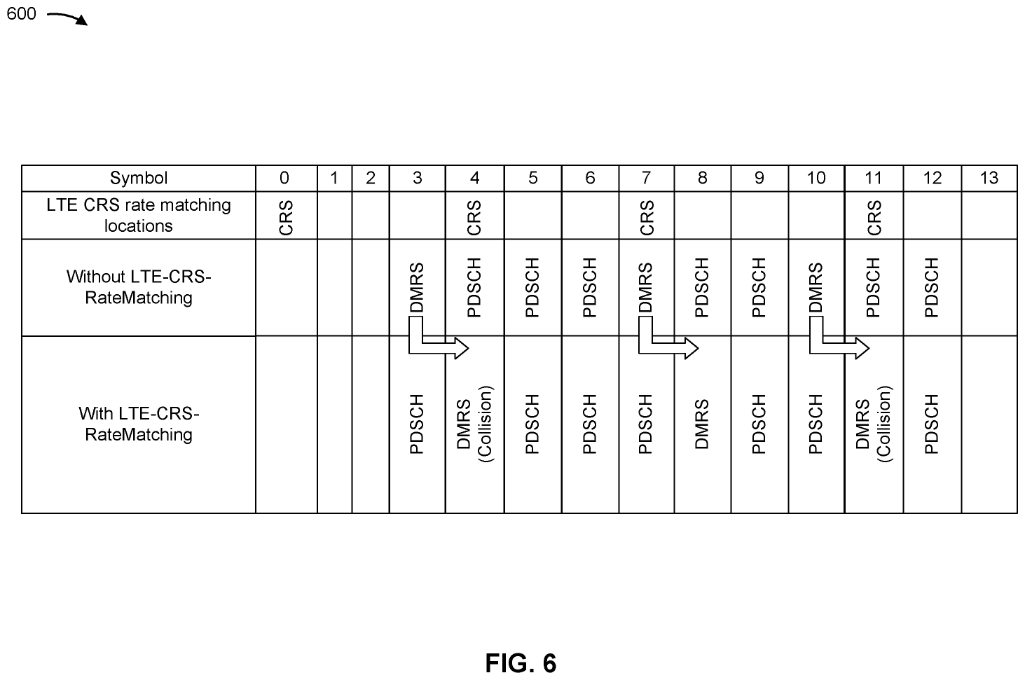

FIG. 6 is a diagram illustrating an instance 600 of a CRS rate-matching scheme that creates a collision between an LTE CRS and an NR DMRS, in accordance with the present disclosure. FIG. 6 shows a slot configured for transmission via FDD at a subcarrier spacing (SCS) of 15 kHz. The slot includes CRSs respectively located at the first symbol of the slot (symbol 0), the fifth symbol of the slot (symbol 4), the eighth symbol of the slot (symbol 7), and the twelfth symbol of the slot (symbol 11).

The slot also includes a Type-B PDSCH scheduled by DCI format 1_0. DCI format 1_0 may be used to schedule a: MSG2 transmission during a random access procedure (e.g., a downlink random access response); MSG4 transmission during a random access procedure (e.g., an RRC connection setup message); system information (SI) (e.g., SI block 1 (SIB 1)) transmission; paging message transmission; physical downlink control channel (PDCCH) order to initiate a random access procedure; dynamic grant transmission; and/or semi-persistent scheduling transmission. A Type-B PDSCH may be a PDSCH with a PDSCH mapping type set to Type B. A Type-B PDSCH may be configurable to start at any symbol of the slot, and may have a maximum possible duration of 10 symbols. By contrast, a Type-A PDSCH may be configurable to start only at symbols 0-3 of a slot, and may have a maximum possible duration of 13 symbols. In instance 600, the Type-B PDSCH starts at the fourth symbol of the slot (symbol 3) and has a duration of ten symbols.

The slot also includes DMRSs multiplexed with the Type-B PDSCH. A DMRS may carry information used to estimate a radio channel for demodulation of an associated physical channel (e.g., PDCCH, PDSCH, physical broadcast channel (PBCH), physical uplink control channel (PUCCH), or physical uplink shared channel (PUSCH)). The PDSCHs scheduled by DCI format 1_0 may be transmitted with three single-symbol DMRSs: one front-loaded DMRS and two additional DMRSs. The two additional DMRSs may be enabled by setting a dmrs-AdditionalPosition parameter to “pos2”.

FIG. 6 shows the positioning of the DMRSs when DSS is configured (e.g., when LTE CRS rate matching is configured, such as when the lte-CRS-ToMatchAround parameter is configured) and when DSS is not configured (e.g., a non-DSS configuration). The non-DSS configuration may provide the positioning of the DMRSs in the absence of LTE/NR coexistence in connection with DSS. In the non-DSS configuration (“Without LTE-CRS-RateMatching”), the slot includes the front-loaded DMRS at a fourth symbol of the slot (symbol 3) and the two additional DMRSs at an eighth symbol of the slot (symbol 7) and an eleventh symbol of the slot (symbol 10).

The non-DSS configuration would lead to a collision, at symbol 7, between one of the CRSs and one of the DMRSs. When DSS is configured and a DMRS associated with Type-B PDSCH having a duration of ten symbols collides with a CRS, all DMRSs in the slot and associated with the Type-B PDSCH may be incremented by one symbol. However, as shown in FIG. 6, when DSS is configured (“With LTE-CRS-RateMatching”), incrementing the DMRSs by one symbol causes the DMRSs to be positioned at symbols 4, 8, and 11, such that the DMRSs at symbols 4 and 11 collide with the CRSs at symbols 4 and 11. Thus, incrementing the DMRSs by one symbol to avoid the collision at symbol 7 may create collisions at symbols 4 and 11.

The UE is not expected to handle instances, such as instance 600, involving collisions between a DMRS and a CRS. As a result, in the scenario illustrated in instance 600, the UE may fail to decode the PDSCH. For instance, if the PDSCH is a PDCCH order to initiate a random access procedure, a MSG2 transmission, or a MSG4 transmission, then the random access procedure may fail. Failure to decode other types of transmissions of the PDSCH scheduled by DCI format 1_0 (e.g., SI transmissions, paging message transmissions, dynamic grant transmissions, semi-persistent scheduling transmissions, or the like) may also prevent or hinder communications between the UE and the network node.

FIG. 7 is a diagram illustrating an instance of a process 700 associated with preventing collisions between CRSs and DMRSs, in accordance with the present disclosure. As shown in FIG. 7, process 700 includes communication between a network node 110 and a UE 120. In some aspects, network node 110 and UE 120 may be included in a wireless network, such as wireless network 100. Network node 110 and UE 120 may communicate via a wireless access link, which may include an uplink and a downlink.

As shown by reference number 710, the network node 110 may transmit, and the UE 120 may receive, in a slot via a DSS spectrum, a plurality of CRSs of a first RAT (e.g., a 4G RAT). The plurality of CRSs may include a first CRS at a first symbol of the slot, a second CRS at a fifth symbol of the slot, a third CRS at an eighth symbol of the slot, and a fourth CRS at a twelfth symbol of the slot.

As shown by reference number 720, the network node 110 may transmit, and the UE 120 may receive, in the slot via the DSS spectrum, a plurality of DMRSs of a second RAT (e.g., a 5G RAT). The plurality of DMRSs may be associated with a Type-B PDSCH scheduled by downlink control information format 1_0, and the Type-B PDSCH may start at a fourth symbol of the slot and have a duration of ten symbols.

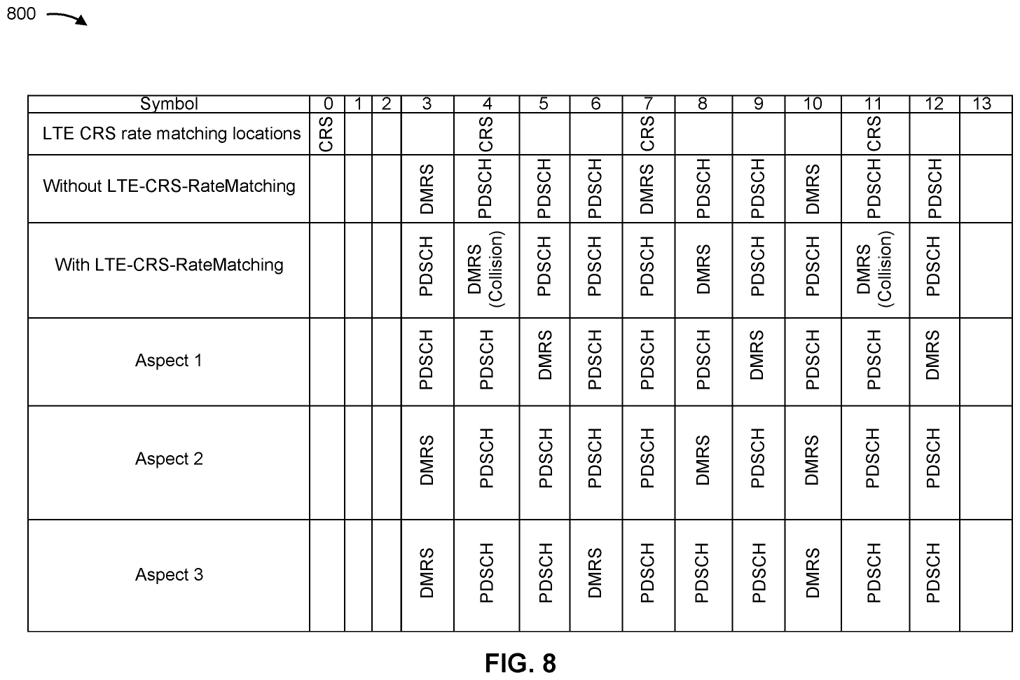

As explained in greater detail below in connection with FIG. 8, the slot contains no collision between any CRS of the first RAT and any DMRS associated with the Type-B PDSCH (e.g., the slot is collision-free). Because the slot contains no collision between any CRS of the first RAT and any DMRS associated with the Type-B PDSCH, the UE may successfully decode the Type-B PDSCH (e.g., based on the DMRSs). For instance, in case the Type-B PDSCH is a PDCCH order to initiate a random access procedure, a MSG2 transmission, or a MSG4 transmission, the random access procedure may succeed. In case the Type-B PDSCH is another type of transmission (e.g., SI transmission, paging message transmission, dynamic grant transmission, semi-persistent scheduling transmission, or the like), the UE may successfully decode the Type-B PDSCH and perform an operation (or refrain from performing an operation) responsive to the Type-B PDSCH.

As indicated above, FIG. 7 is provided as an instance. Other instances may differ from what is described with respect to FIG. 7.

FIG. 8 is a diagram illustrating an instance 800 associated with aspects involving preventing collisions between CRSs and DMRSs. FIG. 8 shows a slot configured for transmission via FDD at a SCS of 15 kHz. As discussed above with reference to FIG. 6, the slot includes CRSs respectively located at the first symbol of the slot (symbol 0), the fifth symbol of the slot (symbol 4), the eighth symbol of the slot (symbol 7), and the twelfth symbol of the slot (symbol 11).

As further discussed above with reference to FIG. 6, the slot includes a Type-B PDSCH scheduled by DCI format 1_0. The Type-B PDSCH starts at the fourth symbol of the slot (symbol 3) and has a duration of ten symbols. The slot also includes three single-symbol DMRSs multiplexed with the Type-B PDSCH. In the non-DSS configuration (“Without LTE-CRS-RateMatching”), the slot includes a front-loaded DMRS at a fourth symbol of the slot (symbol 3) and two additional DMRSs at an eighth symbol of the slot (symbol 7) and an eleventh symbol of the slot (symbol 10). In the DSS configuration (“With LTE-CRS-RateMatching”), the slot includes the DMRSs incremented by one symbol relative to the non-DSS configuration. As noted above with reference to FIG. 6, incrementing the DMRSs by one symbol to avoid a collision with the CRS at symbol 7 may create collisions at symbols 4 and 11.

At least three aspects are provided for preventing (e.g., resolving) collisions in the slot. In a first aspect (“Aspect 1”), each DMRS is incremented by two symbols relative to the non-DSS configuration. In a second aspect (“Aspect 2”), one DMRS (e.g., the DMRS that collides with the CRS at symbol 7 in the non-DSS configuration) is incremented by one symbol relative to the non-DSS configuration. In a third aspect (“Aspect 3”), one DMRS (e.g., the DMRS that collides with the CRS at symbol 7 in the non-DSS configuration) is decremented by one symbol relative to the non-DSS configuration. Aspects 1-3 may be implemented when at least one collision between a DMRS and a CRS persists when all DMRSs (e.g., all DMRS symbol positions) are incremented by one symbol.

In Aspect 1, each DMRS is incremented by two symbols relative to the non-DSS configuration. Thus, the slot includes the front-loaded DMRS at a sixth symbol of the slot (symbol 5) and the two additional DMRSs at a tenth symbol of the slot (symbol 9) and a thirteenth symbol of the slot (symbol 12). Aspect 1 may be backward-compatible for UEs capable of incrementing all the DMRSs, relative to the non-DSS configuration, by one symbol (e.g., shown in FIG. 8 as the DSS configuration (“With LTE-CRS-RateMatching”)). Aspect 1 may be backward-compatible because incrementing all the DMRSs, relative to the non-DSS configuration, by two symbols may include incrementing all the DMRSs, relative to the non-DSS configuration, by one symbol (e.g., incrementing all the DMRSs by two symbols may include incrementing all the DMRSs by one symbol twice).

In Aspect 2, one DMRS (e.g., the DMRS that collides with the CRS at symbol 7 in the non-DSS configuration) is incremented by one symbol relative to the non-DSS configuration. Thus, the slot includes a first DMRS at a fourth symbol of the slot (symbol 3), a second DMRS at a ninth symbol of the slot (symbol 8), and a third DMRS at an eleventh symbol of the slot (symbol 10). The first and third DMRSs are positioned at the same symbols as the first and third DMRSs in the non-DSS configuration, and the second DMRS is incremented by one symbol, from the eighth symbol to the ninth symbol.

In Aspect 3, one DMRS (e.g., the DMRS that collides with the CRS at symbol 7 in the non-DSS configuration) is decremented by one symbol relative to the non-DSS configuration. Thus, the slot includes a first DMRS at a fourth symbol of the slot (symbol 3), a second DMRS at a seventh symbol of the slot (symbol 6), and a third DMRS at an eleventh symbol of the slot (symbol 10). The first and third DMRSs are positioned at the same symbols as the first and third DMRSs in the non-DSS configuration, and the second DMRS is decremented by one symbol, from the eighth symbol to the seventh symbol.

In Aspects 2 and 3, the front-loaded DMRS may be located at the fourth symbol of the slot (symbol 3), which is the symbol where the PDSCH starts. The closer the front-loaded DMRS is to the start of the PDSCH, the more stably the UE may decode the PDSCH. Thus, Aspects 2 and 3may permit the UE to stably decode the PDSCH based on the front-loaded DMRS located at symbol 3.

As indicated above, FIG. 8 is provided as an instance. Other instances may differ from what is described with respect to FIG. 8.

FIG. 9 is a diagram illustrating an instance of a process 900 performed, in some aspects, by a UE, in accordance with the present disclosure. Process 900 is an instance where the UE (e.g., UE 120) performs operations associated with preventing collisions between CRSs and DMRSs.

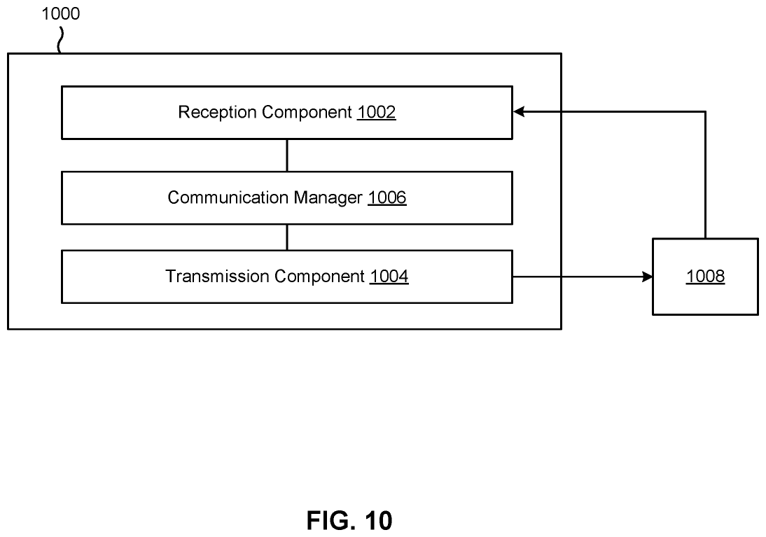

As shown in FIG. 9, in some aspects, process 900 may include receiving, in a slot via a DSS spectrum, a plurality of CRSs of a first RAT (block 910). For instance, the UE (e.g., using reception component 1002 and/or communication manager 1006, depicted in FIG. 10) may receive, in a slot via a DSS spectrum, a plurality of CRSs of a first RAT, as described above.

As further shown in FIG. 9, in some aspects, process 900 may include receiving, in the slot via the DSS spectrum, a plurality of DMRSs of a second RAT, wherein the plurality of DMRSs is associated with a Type-B PDSCH scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH (block 920). For instance, the UE (e.g., using reception component 1002 and/or communication manager 1006, depicted in FIG. 10) may receive, in the slot via the DSS spectrum, a plurality of DMRSs of a second RAT, wherein the plurality of DMRSs is associated with a Type-B PDSCH scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH, as described above.

Process 900 may include additional aspects, such as any single aspect or any combination of aspects described below and/or in connection with one or more other processes described elsewhere herein.

In a first aspect, the first RAT is a 4G RAT and the second RAT is a 5G RAT.

In a second aspect, alone or in combination with the first aspect, the Type-B PDSCH is configurable to start at any symbol of the slot.

In a third aspect, alone or in combination with one or more of the first and second aspects, the plurality of CRSs includes a first CRS at a first symbol of the slot, a second CRS at a fifth symbol of the slot, a third CRS at an eighth symbol of the slot, and a fourth CRS at a twelfth symbol of the slot.

In a fourth aspect, alone or in combination with one or more of the first through third aspects, each DMRS that is in the slot and associated with the Type-B PDSCH is incremented by two symbols relative to a non-DSS configuration of each DMRS that is in the slot and associated with the Type-B PDSCH.

In a fifth aspect, alone or in combination with one or more of the first through fourth aspects, the plurality of DMRSs includes a first DMRS at a sixth symbol of the slot, a second DMRS at a tenth symbol of the slot, and a third DMRS at a thirteenth symbol of the slot.

In a sixth aspect, alone or in combination with one or more of the first through fifth aspects, one DMRS of the plurality of DMRSs is incremented by one symbol relative to a non-DSS configuration of the one DMRS.

In a seventh aspect, alone or in combination with one or more of the first through sixth aspects, the plurality of DMRSs includes a first DMRS at a fourth symbol of the slot, a second DMRS at a ninth symbol of the slot, and a third DMRS at an eleventh symbol of the slot.

In an eighth aspect, alone or in combination with one or more of the first through seventh aspects, one DMRS of the plurality of DMRSs is decremented by one symbol relative to a non-DSS configuration of the one DMRS.

In a ninth aspect, alone or in combination with one or more of the first through eighth aspects, the plurality of DMRSs includes a first DMRS at a fourth symbol of the slot, a second DMRS at a seventh symbol of the slot, and a third DMRS at an eleventh symbol of the slot.

Although FIG. 9 shows blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an instance of an apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for instance, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 7-9. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For instance, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other instances), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other instances), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For instance, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, in a slot via a DSS spectrum, a plurality of CRSs of a first RAT. The reception component 1002 may receive, in the slot via the DSS spectrum, a plurality of DMRSs of a second RAT, wherein the plurality of DMRSs is associated with a Type-B PDSCH scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

The number and arrangement of components shown in FIG. 10 are provided as an instance. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

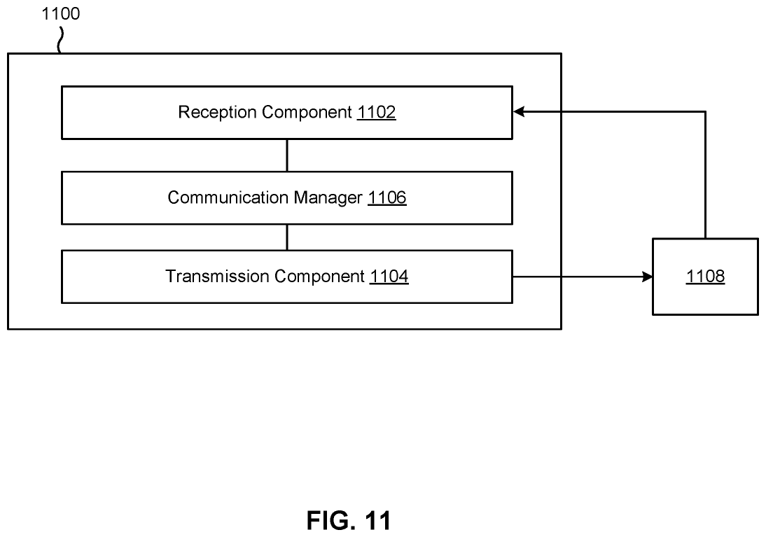

FIG. 11 is a diagram of an instance of an apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for instance, via one or more buses and/or one or more other components).

As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 7 or 8. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For instance, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other instances), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other instances), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1106 may support operations of the reception component 1102 and/or the transmission component 1104. For instance, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The number and arrangement of components shown in FIG. 11 are provided as an instance. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving, in a slot via a DSS spectrum, a plurality of CRSs of a first RAT; and receiving, in the slot via the DSS spectrum, a plurality of DMRSs of a second RAT. wherein the plurality of DMRSs is associated with a Type-B PDSCH scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

Aspect 2: The method of Aspect 1, wherein the first RAT is a 4G RAT and the second RAT is a 5G RAT.

Aspect 3: The method of any of Aspects 1-2, wherein the Type-B PDSCH is configurable to start at any symbol of the slot.

Aspect 4: The method of any of Aspects 1-3, wherein the plurality of CRSs includes a first CRS at a first symbol of the slot, a second CRS at a fifth symbol of the slot, a third CRS at an eighth symbol of the slot, and a fourth CRS at a twelfth symbol of the slot.

Aspect 5: The method of any of Aspects 1-4, wherein each DMRS that is in the slot and associated with the Type-B PDSCH is incremented by two symbols relative to a non-DSS configuration of each DMRS that is in the slot and associated with the Type-B PDSCH.

Aspect 6: The method of Aspect 5, wherein the plurality of DMRSs includes a first DMRS at a sixth symbol of the slot, a second DMRS at a tenth symbol of the slot, and a third DMRS at a thirteenth symbol of the slot.

Aspect 7: The method of any of Aspects 1-6, wherein one DMRS of the plurality of DMRSs is incremented by one symbol relative to a non-DSS configuration of the one DMRS.

Aspect 8: The method of Aspect 7, wherein the plurality of DMRSs includes a first DMRS at a fourth symbol of the slot, a second DMRS at a ninth symbol of the slot, and a third DMRS at an eleventh symbol of the slot.

Aspect 9: The method of any of Aspects 1-8, wherein one DMRS of the plurality of DMRSs is decremented by one symbol relative to a non-DSS configuration of the one DMRS.

Aspect 10: The method of Aspect 9, wherein the plurality of DMRSs includes a first DMRS at a fourth symbol of the slot, a second DMRS at a seventh symbol of the slot, and a third DMRS at an eleventh symbol of the slot.

Aspect 11: An apparatus for wireless communication at a device, comprising a processor; memory coupled with the processor; and instructions stored in the memory and executable by the processor to cause the apparatus to perform the method of one or more of Aspects 1-10.

Aspect 12: A device for wireless communication, comprising a memory and one or more processors coupled to the memory, the one or more processors configured to perform the method of one or more of Aspects 1-10.

Aspect 13: An apparatus for wireless communication, comprising at least one means for performing the method of one or more of Aspects 1-10.

Aspect 14: A non-transitory computer-readable medium storing code for wireless communication, the code comprising instructions executable by a processor to perform the method of one or more of Aspects 1-10.

Aspect 15: A non-transitory computer-readable medium storing a set of instructions for wireless communication, the set of instructions comprising one or more instructions that, when executed by one or more processors of a device, cause the device to perform the method of one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other instances, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an instance, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE), comprising:
one or more memories; and
one or more processors, coupled to the one or more memories, configured to:
receive, in a slot via a dynamic spectrum sharing (DSS) spectrum, a plurality of cell-specific reference signals (CRSs) of a first radio access technology (RAT); and
receive, in the slot via the DSS spectrum, a plurality of demodulation reference signals (DMRSs) of a second RAT, wherein the plurality of DMRSs is associated with a Type-B physical downlink shared channel (PDSCH) scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

2. The UE of claim 1, wherein the first RAT is a 4G RAT and the second RAT is a 5G RAT.

3. The UE of claim 1, wherein the Type-B PDSCH is configurable to start at any symbol of the slot.

4. The UE of claim 1, wherein the plurality of CRSs includes a first CRS at a first symbol of the slot, a second CRS at a fifth symbol of the slot, a third CRS at an eighth symbol of the slot, and a fourth CRS at a twelfth symbol of the slot.

5. The UE of claim 1, wherein each DMRS that is in the slot and associated with the Type-B PDSCH is incremented by two symbols relative to a non-DSS configuration of each DMRS that is in the slot and associated with the Type-B PDSCH.

6. The UE of claim 5, wherein the plurality of DMRSs includes a first DMRS at a sixth symbol of the slot, a second DMRS at a tenth symbol of the slot, and a third DMRS at a thirteenth symbol of the slot.

7. The UE of claim 1, wherein one DMRS of the plurality of DMRSs is incremented by one symbol relative to a non-DSS configuration of the one DMRS.

8. The UE of claim 7, wherein the plurality of DMRSs includes a first DMRS at a fourth symbol of the slot, a second DMRS at a ninth symbol of the slot, and a third DMRS at an eleventh symbol of the slot.

9. The UE of claim 1, wherein one DMRS of the plurality of DMRSs is decremented by one symbol relative to a non-DSS configuration of the one DMRS.

10. The UE of claim 9, wherein the plurality of DMRSs includes a first DMRS at a fourth symbol of the slot, a second DMRS at a seventh symbol of the slot, and a third DMRS at an eleventh symbol of the slot.

11. A method of wireless communication performed by a user equipment (UE), comprising:
receiving, in a slot via a dynamic spectrum sharing (DSS) spectrum, a plurality of cell-specific reference signals (CRSs) of a first radio access technology (RAT); and
receiving, in the slot via the DSS spectrum, a plurality of demodulation reference signals (DMRSs) of a second RAT, wherein the plurality of DMRSs is associated with a Type-B physical downlink shared channel (PDSCH) scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

12. The method of claim 11, wherein the first RAT is a 4G RAT and the second RAT is a 5G RAT.

13. The method of claim 11, wherein the Type-B PDSCH is configurable to start at any symbol of the slot.

14. The method of claim 11, wherein the plurality of CRSs includes a first CRS at a first symbol of the slot, a second CRS at a fifth symbol of the slot, a third CRS at an eighth symbol of the slot, and a fourth CRS at a twelfth symbol of the slot.

15. The method of claim 11, wherein each DMRS that is in the slot and associated with the Type-B PDSCH is incremented by two symbols relative to a non-DSS configuration of each DMRS that is in the slot and associated with the Type-B PDSCH.

16. The method of claim 15, wherein the plurality of DMRSs includes a first DMRS at a sixth symbol of the slot, a second DMRS at a tenth symbol of the slot, and a third DMRS at a thirteenth symbol of the slot.

17. The method of claim 11, wherein one DMRS of the plurality of DMRSs is incremented by one symbol relative to a non-DSS configuration of the one DMRS.

18. The method of claim 17, wherein the plurality of DMRSs includes a first DMRS at a fourth symbol of the slot, a second DMRS at a ninth symbol of the slot, and a third DMRS at an eleventh symbol of the slot.

19. The method of claim 11, wherein one DMRS of the plurality of DMRSs is decremented by one symbol relative to a non-DSS configuration of the one DMRS.

20. The method of claim 19, wherein the plurality of DMRSs includes a first DMRS at a fourth symbol of the slot, a second DMRS at a seventh symbol of the slot, and a third DMRS at an eleventh symbol of the slot.

21. An apparatus, comprising:
means for receiving, in a slot via a dynamic spectrum sharing (DSS) spectrum, a plurality of cell-specific reference signals (CRSs) of a first radio access technology (RAT); and
means for receiving, in the slot via the DSS spectrum, a plurality of demodulation reference signals (DMRSs) of a second RAT, wherein the plurality of DMRSs is associated with a Type-B physical downlink shared channel (PDSCH) scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

22. The apparatus of claim 21, wherein the plurality of CRSs includes a first CRS at a first symbol of the slot, a second CRS at a fifth symbol of the slot, a third CRS at an eighth symbol of the slot, and a fourth CRS at a twelfth symbol of the slot.

23. The apparatus of claim Error! Reference source not found., wherein each DMRS that is in the slot and associated with the Type-B PDSCH is incremented by two symbols relative to a non-DSS configuration of each DMRS that is in the slot and associated with the Type-B PDSCH.

24. The apparatus of claim Error! Reference source not found., wherein one DMRS of the plurality of DMRSs is incremented by one symbol relative to a non-DSS configuration of the one DMRS.

25. The apparatus of claim Error! Reference source not found., wherein one DMRS of the plurality of DMRSs is decremented by one symbol relative to a non-DSS configuration of the one DMRS.

26. A non-transitory computer-readable medium storing a set of instructions, the set of instructions comprising:
one or more instructions that, when executed by one or more processors of a user equipment (UE), cause the UE to:
receive, in a slot via a dynamic spectrum sharing (DSS) spectrum, a plurality of cell-specific reference signals (CRSs) of a first radio access technology (RAT); and
receive, in the slot via the DSS spectrum, a plurality of demodulation reference signals (DMRSs) of a second RAT, wherein the plurality of DMRSs is associated with a Type-B physical downlink shared channel (PDSCH) scheduled by downlink control information format 1_0, wherein the Type-B PDSCH starts at a fourth symbol of the slot and has a duration of ten symbols, and wherein the slot contains no collision between any CRS of the first RAT and any DMRS associated with the Type-B PDSCH.

27. The non-transitory computer-readable medium of claim Error! Reference source not found., wherein the plurality of CRSs includes a first CRS at a first symbol of the slot, a second CRS at a fifth symbol of the slot, a third CRS at an eighth symbol of the slot, and a fourth CRS at a twelfth symbol of the slot.

28. The non-transitory computer-readable medium of claim Error! Reference source not found., wherein each DMRS that is in the slot and associated with the Type-B PDSCH is incremented by two symbols relative to a non-DSS configuration of each DMRS that is in the slot and associated with the Type-B PDSCH.

29. The non-transitory computer-readable medium of claim Error! Reference source not found., wherein one DMRS of the plurality of DMRSs is incremented by one symbol relative to a non-DSS configuration of the one DMRS.

30. The non-transitory computer-readable medium of claim Error! Reference source not found., wherein one DMRS of the plurality of DMRSs is decremented by one symbol relative to a non-DSS configuration of the one DMRS.
